(19) United States
(12) Patent Application Publication
(10) Pub. No.: US 2025/0095287 A1
(43) Pub. Date: Mar. 20, 2025

(54) DEVICE, METHOD AND PROGRAM THAT CREATE 3D MODELS

(71) Applicant: NIPPON TELEGRAPH AND TELEPHONE CORPORATION, Tokyo (JP)

(72) Inventors: Yusuke SAKURAHARA, Musashino-shi, Tokyo (JP); Yukihiro GOTO, Musashino-shi, Tokyo (JP); Masaki WAKI, Musashino-shi, Tokyo (JP); Takashi EBINE, Musashino-shi, Tokyo (JP)

(73) Assignee: NIPPON TELEGRAPH AND TELEPHONE CORPORATION, Tokyo (JP)

(21) Appl. No.: 18/727,325

(22) PCT Filed: Jan. 14, 2022
(86) PCT No.: PCT/JP2022/001022

§ 371 Date: Jul. 8, 2024

(51) Int. Cl. G06T 17/00

(52) U.S. Cl. CPC G06T 17/00; G06T 2210/56

(57) ABSTRACT

An object of the present disclosure is to enable a three-dimensional model to be created even for a target object which has unevenly spaced inter-point distances and only a part of a point cloud.

According to the present disclosure, there are provided an apparatus and a method in which, a three-dimensional model of a target object is created from point cloud data in which each point represents three-dimensional coordinates, the three-dimensional model is superimposed on an image in which a target object of the three-dimensional model is photographed, a superimposed image generated by the superimposition is displayed, and when a range of the target object in the superimposed image is input, a three-dimensional model is created again using point cloud data in which a point is located in a range of the superimposed image.

### TECHNICAL FIELD

The present disclosure relates to a technology for creating a three-dimensional model from point cloud data representing three-dimensional coordinates.

### BACKGROUND ART

A technology for three-dimensionally modeling an outdoor structure by an in-vehicle three-dimensional laser scanner (mobile mapping system: MMS) has been developed (for example, refer to Patent Literature 1). In the technology of Patent Literature 1, a point cloud and a scan line are created in a space where no point cloud exists, and then a three-dimensional model is created.

There is a need to realize three-dimensional modeling of cylindrical objects using point cloud data acquired by a fixed three-dimensional laser scanner. However, since the MMS can acquire the point cloud while moving along the target object, the point cloud of the measurement range can be acquired evenly and at equal intervals to some extent. However, the fixed three-dimensional laser scanner produces a dense point cloud at a short distance from the measurement point, and a sparse point cloud at a long distance. Therefore, in the creation of the three-dimensional model using the point cloud data acquired by the fixed three-dimensional laser scanner, this characteristic significantly appears depending on the size and shape of the target object.

In the related art, points are interpolated until the distance between point clouds reach a certain threshold to form a scan line. However, in a case where the distance between point clouds is large and the point clouds are not regarded as point clouds on the same target object, no point can be interpolated between points. Therefore, in the three-dimensional modeling by the fixed three-dimensional laser scanner, a problem arises in that it is difficult to create a three-dimensional model of a target object having a small diameter, such as a cable on a utility pole.

### CITATION LIST

### Patent Literature

Patent Literature 1: JP 2017-156179 A

### SUMMARY OF INVENTION

### Technical Problem

An object of the present disclosure is to enable a three-dimensional model to be created even for a target object which has unevenly spaced inter-point distances and only a part of a point cloud.

### Solution to Problem

According to the present disclosure, there are provided an apparatus and a method in which,
a three-dimensional model of a target object is created from point cloud data in which each point represents three-dimensional coordinates,
the three-dimensional model is superimposed on an image in which a target object of the three-dimensional model is photographed,
a superimposed image generated by the superimposition is displayed, and
when a range of the target object in the superimposed image is input, a three-dimensional model is created again using point cloud data in which a point is located in a range of the superimposed image.

### ADVANTAGEOUS EFFECTS OF INVENTION

According to the present disclosure, it is possible to create a three-dimensional model of a target object not depending on the distance between three-dimensional points. Therefore, the present disclosure enables a three-dimensional model to be created even for a target object which has unevenly spaced inter-point distances and only a part of a point cloud.

### BRIEF DESCRIPTION OF DRAWINGS

FIG. 1 illustrates an example of point cloud data.

FIG. 2 illustrates an example of a three-dimensional model in which a structure is objectified.

FIG. 3 illustrates a system configuration example according to the present disclosure.

FIG. 4 illustrates an example of a point cloud stored in a storage medium.

FIG. 5 illustrates an example of an image stored in the storage medium.

FIG. 6 illustrates an example of a method of the present embodiment.

FIG. 7 illustrates an example of a three-dimensional model created in step S1.

FIG. 8 illustrates an example of a superimposed image in which a three-dimensional model is superimposed on an image.

FIG. 9 illustrates an example of a three-dimensional model created in step S3.

FIG. 10 illustrates an example of input of a range of a target object.

FIG. 11 illustrates a specific example of step S3.

FIG. 12 illustrates an example of a first method of comparing sizes of target objects.

FIG. 13 illustrates an example of adding a point cloud constituting the three-dimensional model.

FIG. 14 illustrates an example of a corrected three-dimensional model.

FIG. 15 illustrates an example of a second method of comparing sizes of target objects.

FIG. 16 illustrates an example of display of a size of a target object.

FIG. 17 illustrates a specific example of step S3.

FIG. 18 illustrates an example of a state where a three-dimensional model extends.

FIG. 19 illustrates a setting example of an endpoint of the three-dimensional model.

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be carried out in forms of various modifications and improvements based on knowledge of those skilled in the art. Components assigned the same reference numerals in the present specification and the drawings are the same components.

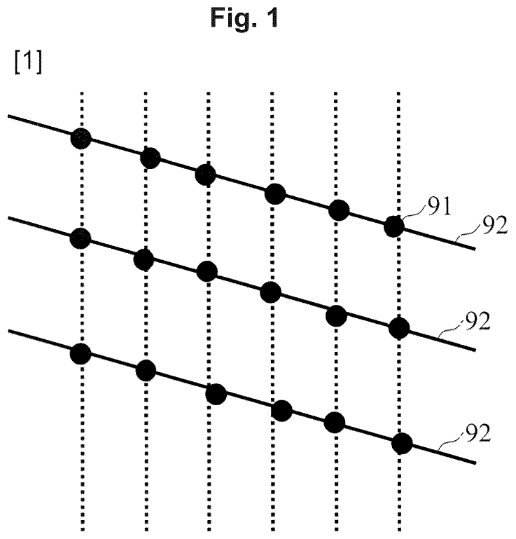

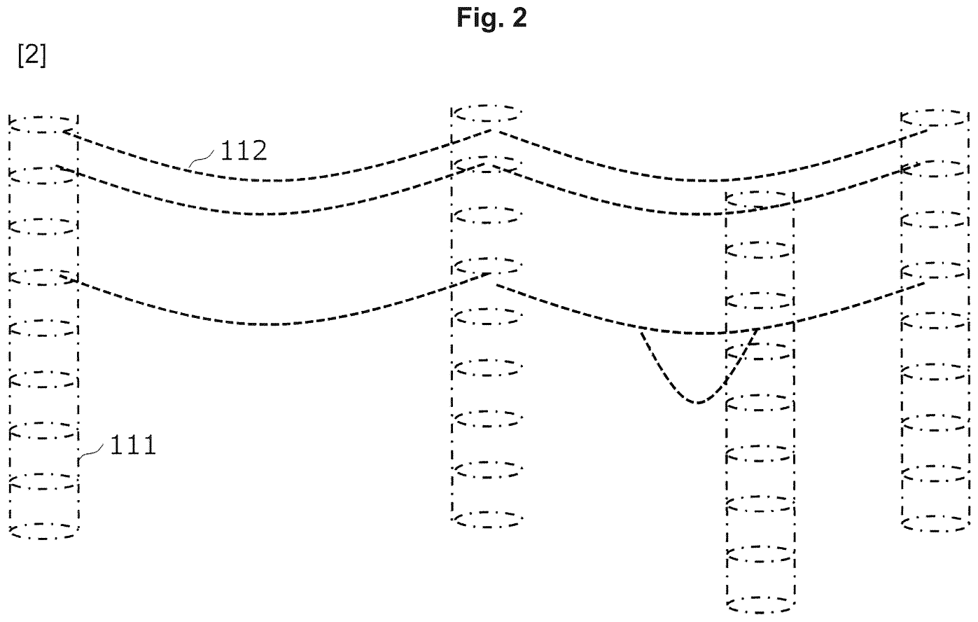

The present disclosure provides an apparatus and a method for creating a three-dimensional model of a target object from point cloud data representing three-dimensional coordinates acquired by a three-dimensional laser scanner. FIG. 1 illustrates an example of point cloud data. The point cloud data is data representing a surface shape of a target object such as a structure as a set of points 91, and individual points 91 represent three-dimensional coordinates on a surface of the structure. By forming a line 92 connecting the points 91 of the three-dimensional point cloud data, it is possible to create a three-dimensional model in which a structure is objectified. For example, as illustrated in FIG. 2, a three-dimensional utility pole model 111 and a cable model 112 can be created.

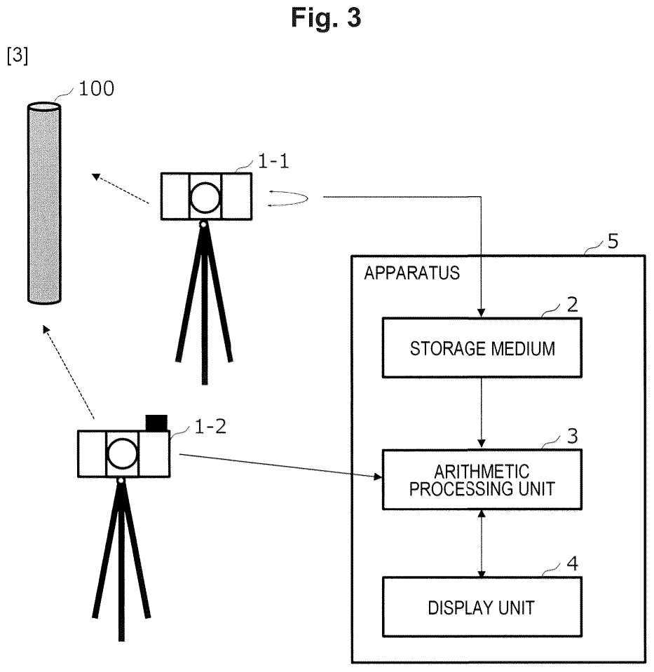

FIG. 3 illustrates a system configuration example of the present disclosure. The system of the present disclosure includes a fixed three-dimensional laser scanner 1-1 for measuring a target object 100, a camera 1-2 for imaging the target object 100, and an apparatus 5 of the present disclosure. The apparatus 5 of the present disclosure includes an arithmetic processing unit 3 and a display unit 4, and may further include a storage medium 2. Further, the apparatus 5 of the present disclosure can also be implemented by a computer and a program, and the program can be recorded in a recording medium or provided through a network.

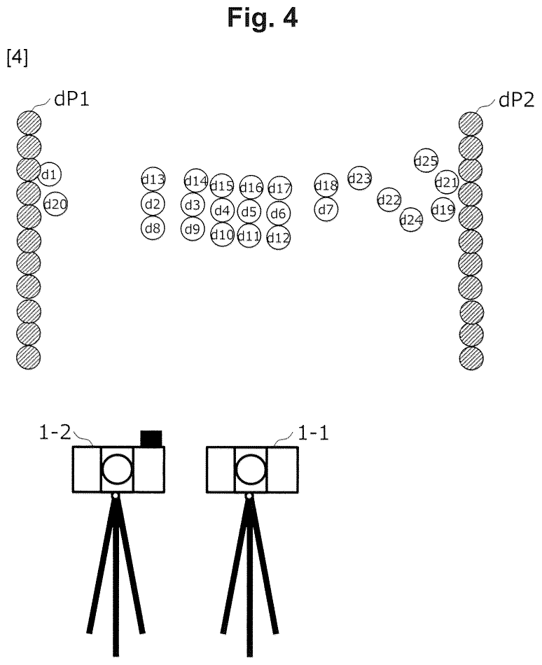

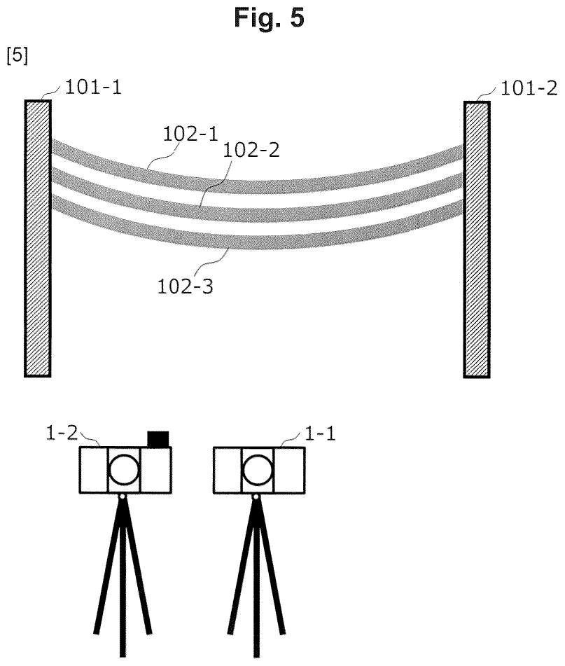

The system of the present disclosure stores the point cloud data acquired by the fixed three-dimensional laser scanner 1-1 and the image captured by the camera 1-2 in the storage medium 2. FIG. 4 illustrates an example of a point cloud stored in the storage medium 2. In the present embodiment, the points d1 to d25 are stored between the measured point clouds dp1 and dp2 of the utility pole. FIG. 5 illustrates an example of an image stored in the storage medium 2. In the present embodiment, an image in which the cables 102-1, 102-2, and 102-3 are stretched between the utility poles 101-1 and 101-2 is stored.

The camera 1-2 may be a camera mounted on the fixed three-dimensional laser scanner 1-1 or may be prepared separately. In addition, the camera 1-2 desirably captures an image at a position, a direction, and an angle of view similar to the position, the direction, and the angle of view at which the fixed three-dimensional laser scanner 1-1 acquires the point cloud. Accordingly, superimposition of the point cloud acquired by the fixed three-dimensional laser scanner 1-1 and the image captured by the camera 1-2 is facilitated. However, since the point cloud of the present disclosure has three-dimensional coordinates, it is possible to superimpose the point cloud on the image based on the relative position as long as there is the three-dimensional position information of the fixed three-dimensional laser scanner 1-1 and the camera 1-2.

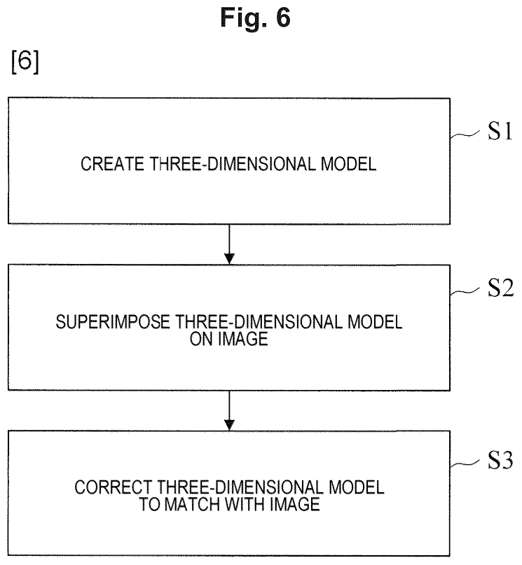

FIG. 6 illustrates an example of a method of the present embodiment. The method according to the present embodiment, which is
a method of generating a three-dimensional model of a target object from point cloud data acquired by the three-dimensional laser scanner 1-1, the method including:
a step S1 of creating, by the arithmetic processing unit 3, a three-dimensional model of the target object from the three-dimensional point cloud data;
a step S2 of superimposing, by the arithmetic processing unit 3, the created three-dimensional model of the target object on the image of the target object; and
a step S3 of correcting, by the arithmetic processing unit 3, the three-dimensional model based on the comparison between the three-dimensional model and the superimposed image.

In step S1, a target object is extracted from the point cloud and a three-dimensional model is created (DBSCAN). Here, DBSCAN is one clustering technique and is a technique in which a point cloud included in the condition that there are more than a certain number of points within the threshold of a certain point is considered as a mass and is treated as a cluster. The target object is, for example, the utility poles 101-1 and 101-2 or cables 102-1, 102-2, and 102-3. Hereinafter, an example in which the target objects are the cables 102-1, 102-2, and 102-3 will be described.

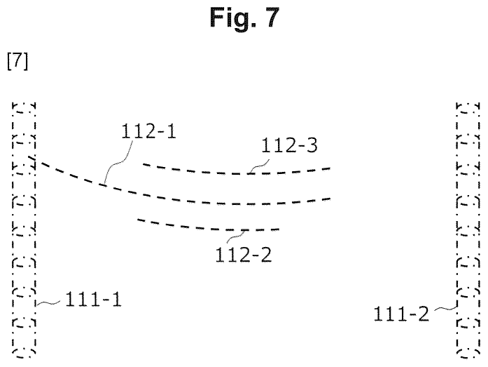

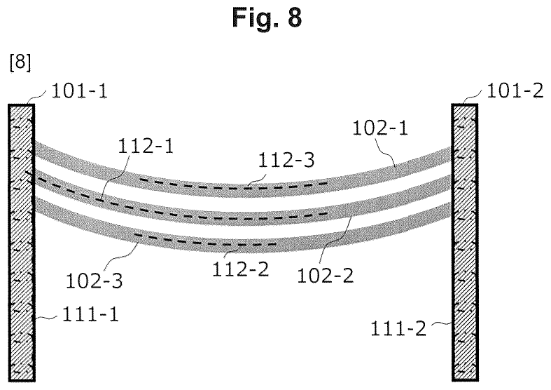

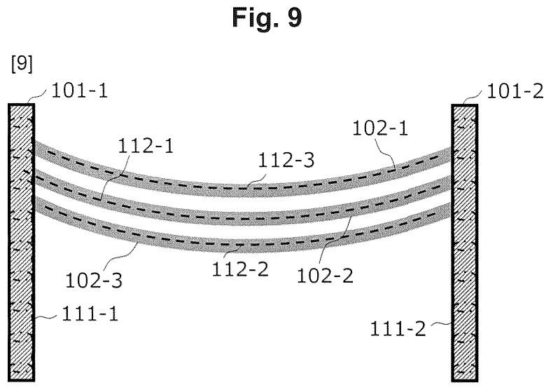

FIG. 7 illustrates an example of three-dimensional models 112-1, 112-2, and 112-3 created in step S1. In step S2, the three-dimensional models 112-1, 112-2, and 112-3 are superimposed on an image as illustrated in FIG. 8. Then, by comparing the three-dimensional models 112-1, 112-2, and 112-3 with the cables 102-1, 102-2, and 102-3 in the image in step S3, the three-dimensional models 112-1, 112-2, and 112-3 are corrected as illustrated in FIG. 9. As a result, the present disclosure can calculate facility information (looseness, span length, and the like) from the corrected three-dimensional model.

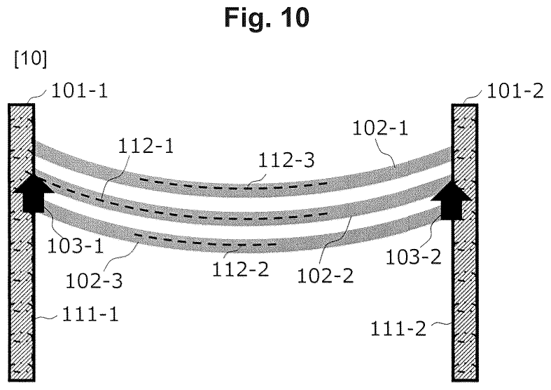

In the present disclosure, in step S2, the superimposed image generated by the superimposition is displayed on the display unit 4. Then, when the range of the target object in the superimposed image is input by the user as with cursors 103-1 and 103-2 illustrated in FIG. 10, the arithmetic processing unit 3 executes step S3. In step S3, the arithmetic processing unit 3 creates the three-dimensional model again using the point cloud data in which the point is located in the range of the superimposed image.

In the present disclosure, it is possible to determine whether the three-dimensional model has been completely created by superimposing the image in step S2, and in step S3, the existing three-dimensional model can be left as it is, and when the three-dimensional model is insufficient, the three-dimensional model can be added. As a result, the present disclosure can determine the presence or absence of a target object even when the target object has only a part of the point cloud. Therefore, the present disclosure can construct a three-dimensional model of a thin line-shaped target object such as a suspension line, an optical cable, an electric wire, or a horizontal support line. Furthermore, the present disclosure can construct a three-dimensional model of a target object in a thin line shape, and thus it is possible to detect a state of target facility in a thin line shape.

A method of inputting the range of the target object in step S2 is random. For example, as illustrated in FIG. 10, the range may be input by using the position of the cursor on the screen or by dragging.

In addition, in step S3, a method of correcting the three-dimensional model is random. In the present embodiment, a mode of interpolating a point to be matched with an image and a mode of interpolating a three-dimensional model to be matched with an image will be exemplified.

### First Embodiment

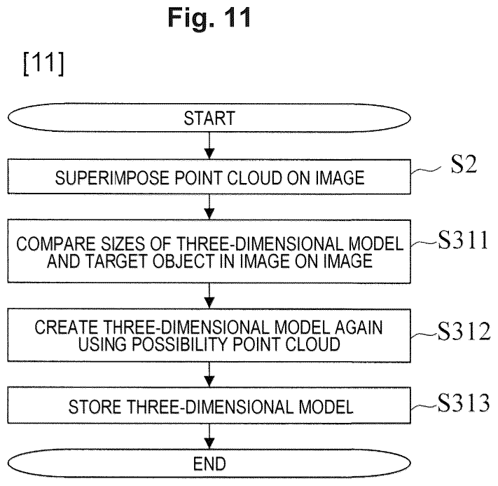

FIG. 11 illustrates a specific example of step S3. In the present embodiment, the arithmetic processing unit 3 superimposes the created three-dimensional model on the photographed image (S2), and displays the superimposed image generated by the superimposition on the display unit 4. The arithmetic processing unit 3 acquires the range of the target object in the superimposed image, and compares the sizes of the three-dimensional model and the target object in the image on the superimposed image (S311). When the target object in the image is larger, the point is interpolated to create a three-dimensional model (S312), and the three-dimensional model is stored in the storage medium 2 (S313).

In step S312, a method of superimposing the image and the point cloud and comparing the size of the target object is random, but for example, the following method can be exemplified.

First method: A method of superimposing a point cloud and an image, and comparing the pixel size of the same color designated in a superimposed image with the size of a three-dimensional model.

Second method: A method of collating facility information in a database prepared in advance, and comparing the size of the collated information with the size of a three-dimensional model.

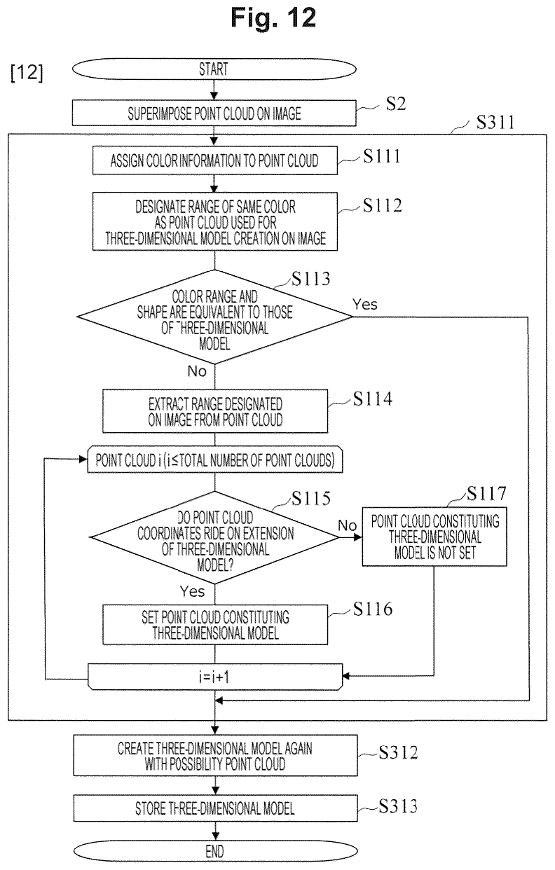

FIG. 12 illustrates an example of the first method. In the first method, it is determined how many point clouds indicating the cable are used to create the three-dimensional model of the cable. Specifically, the arithmetic processing unit 3 superimposes the image (S2), assigns the color information of the cable to the point cloud (S111), and acquires a range of how far the same color pixel of the point cloud used for the three-dimensional model creation extends on the image (S112). When the color range and shape are different from the three-dimensional model (No in S113), the arithmetic processing unit 3 extracts the point cloud included in the designated range in S112 (S114 to S117), and creates the three-dimensional model again (S312 and S313).

Specifically, in step S111, after the superimposition, the point cloud and the image are associated with each other, and color information of the image at the same position on the image is assigned to each point cloud. For example, the three-dimensional model 112-1 overlaps the cable 102-2. In this case, the point clouds d1 to d6 constituting the three-dimensional model 112-1 are associated with the cable 102-2, and the color information of the cable 102-2 is assigned to the point clouds d1 to d6.

In step S112, similar to the cursors 103-1 and 103-2 illustrated in FIG. 10, the user manually selects how far the pixels of the same color as the point clouds d1 to d6 corresponding to the extracted three-dimensional model 112-1 extend on the image. As a result, a range in which the same color as that of the cable 102-2 spreads is designated on the image, and the three-dimensional model is created again from the point clouds d1 to d25 within the range using the point cloud within the threshold designated in advance from the extension line of the approximate line of the three-dimensional model (S113 to S117, and S312).

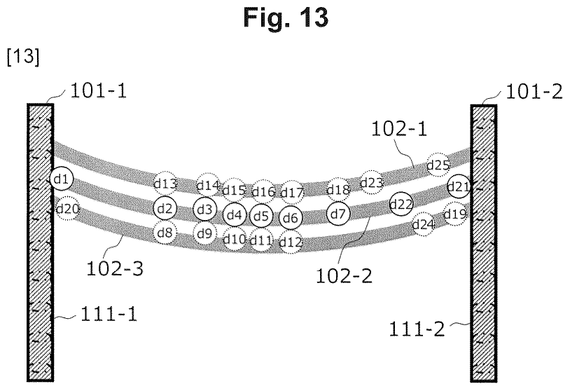

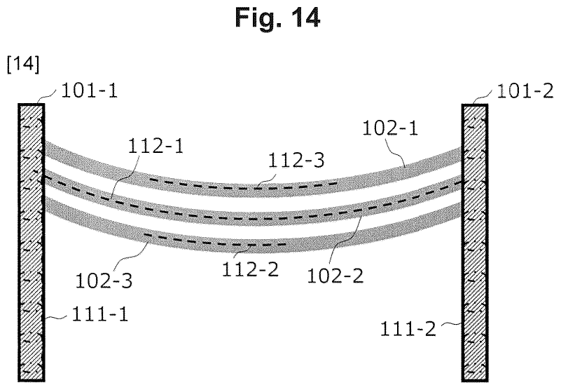

Here, for example, regarding the threshold, assuming that a direction in which an approximate line of the three-dimensional model 112-1 extends is an x axis, a depth is a y axis, and a height direction is a z axis, each inter-point distance is set to Δx<30 mm, Δy<30 mm, and Δz<30 mm, and a point cloud that will be used for the three-dimensional model can be extracted. As a result, as illustrated in FIGS. 13, d21 and d22 are set as a point cloud constituting the three-dimensional model (S116), and the three-dimensional model is created again (S312). As a result, as illustrated in FIG. 14, the three-dimensional model 112-1 can be corrected. As described above, in the present embodiment, the coordinates of the point cloud extracted in steps S114 to S117 are also used for correction of the three-dimensional model 112-1, and accordingly, it can be determined whether the coordinates can be used for the three-dimensional model even when the pixels of the same color extend in a wide range.

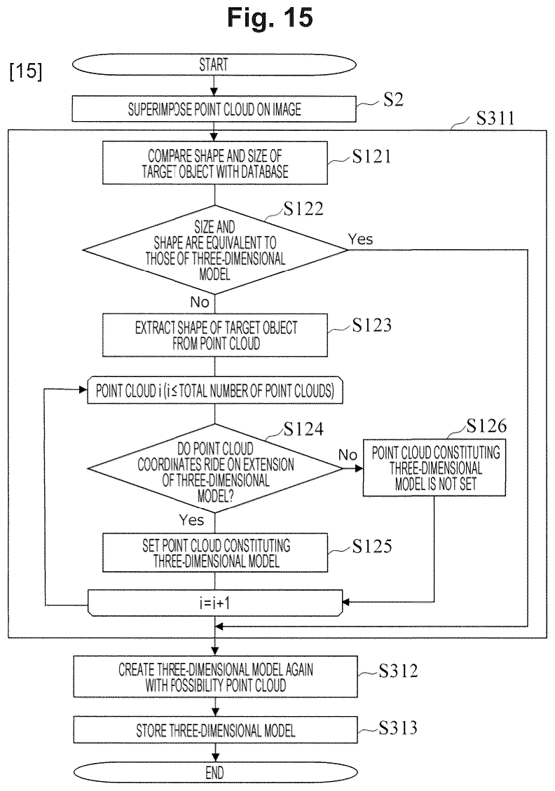

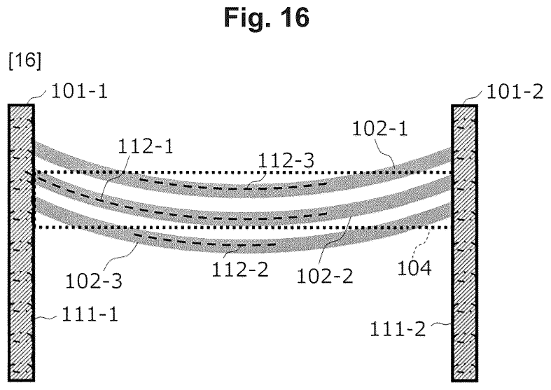

FIG. 15 illustrates an example of the second method. In the second method, the arithmetic processing unit 3 superimposes the three-dimensional model on the image (S2), and displays information of the cable such as the slackness, the span length, and the position on the database stored in advance and the three-dimensional model in a comparable manner (S121). For example, as illustrated in FIG. 16, the arithmetic processing unit 3 displays a range 104 indicating the size of the cable 102-2 on the display unit 4. As a result, the user can determine the range of the cable 102-2 even when the image is unclear.

When acquiring the range of the cable 102-2 such as the cursors 103-1 and 103-2 illustrated in FIG. 10, the arithmetic processing unit 3 extracts a point cloud to have the same size and shape as the information of the cable (S122 to S126) and creates a three-dimensional model (S312 and S313). Similarly to the first method, by using the coordinates of the point cloud, it is possible to determine whether the pixel of the same color can be used for the three-dimensional model even when the pixel extends in a wide range.

In the present embodiment, the three-dimensional model 112-1 overlaps the cable 102-2. In this case, in step S121, when the three-dimensional model 112-1 is selected, the arithmetic processing unit 3 selects the cable 102-2, which is a target object to be compared with the three-dimensional model 112-1, on the superimposed image. Then, the corresponding target object is searched from a database prepared in advance based on the position and length of the selected cable 102-2, and information such as the size, shape, position, and the like is retrieved.

Furthermore, in steps S122 to S126, the arithmetic processing unit 3 may compare the three-dimensional model 112-1 with the information of the cable 102-2 in the database, and in a case where the cable 102-2 on the database is larger or has a different shape, the arithmetic processing unit 3 may extract the point cloud possibilities constituting the three-dimensional model 112-1 from the point clouds d1 to d25 based on the information of the database. Then, the arithmetic processing unit 3 creates the three-dimensional model again from the point clouds d1 to d25 within the target object range using the point cloud within the threshold designated in advance from the extension line of the approximate line of the three-dimensional model. The concept of the threshold is similar to that of S114 to S117.

As described above, in the present embodiment, since the point cloud can be added to the place where the point cloud does not exist between the endpoints, the three-dimensional model of the target object can be accurately created even in a case where the target object has unevenly spaced inter-point distances and only a part of a point cloud.

### Second Embodiment

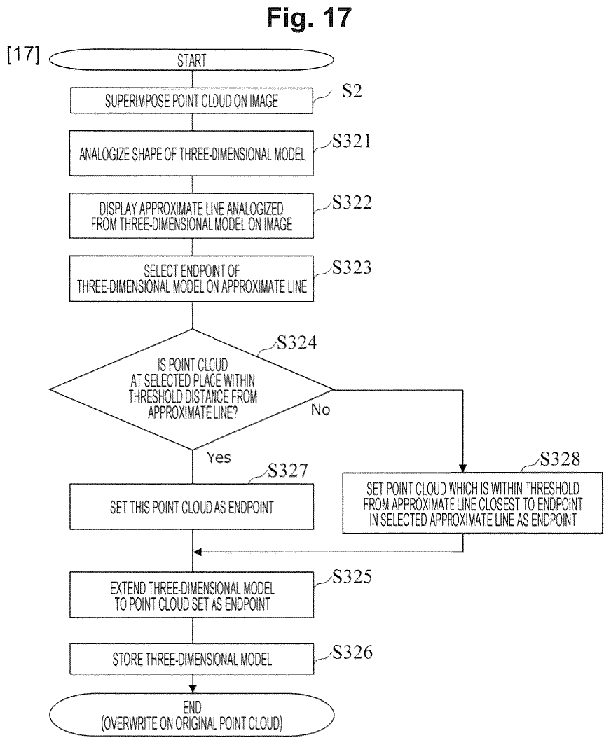

FIG. 17 illustrates a specific example of step S3. In the present embodiment, the created three-dimensional model shape is estimated. The created three-dimensional model is superimposed on the image (S2), the shape of the three-dimensional model is analogized (S321), an approximate line analogized from the three-dimensional model is displayed on the image (S322), an endpoint of the approximate line is selected on the superimposed image (S323), and when a point cloud exists near the selection place and within a threshold from the approximate line (S324), the three-dimensional model is created again using the point as the endpoint (S325), and the three-dimensional model is stored (S326).

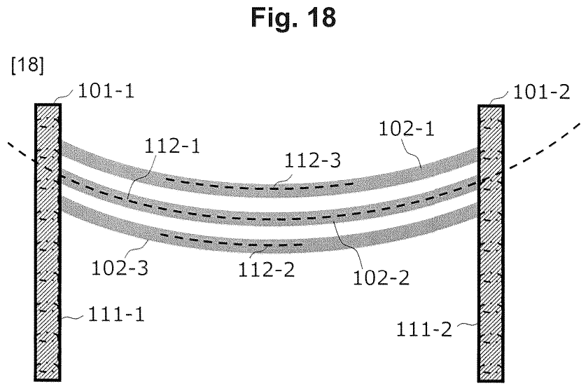

For example, as illustrated in FIG. 8, the arithmetic processing unit 3 superimposes the three-dimensional model 112-1 on the image (S2). Then, the arithmetic processing unit 3 extracts the approximate line of the three-dimensional model 112-1, extends the approximate line of the three-dimensional model 112-1 as illustrated in FIG. 18, and displays the extended approximate line on the display unit 4 (S322). When acquiring the range of the cable 102-2 such as the cursors 103-1 and 103-2 illustrated in FIG. 10, the arithmetic processing unit 3 rides on the approximate line and creates the three-dimensional model again using the point cloud in the range of the cursors 103-1 and 103-2 (S323 to S327). Here, as the approximate line, an approximate curve or a catenary curve can be used.

In the present embodiment, in step S323, an image in which the approximate line of the three-dimensional model 112-1 intersects the utility poles 101-1 and 101-2 is displayed on the display unit 4. Therefore, the user can easily select the endpoint of the three-dimensional model with the human eyes using the intersection.

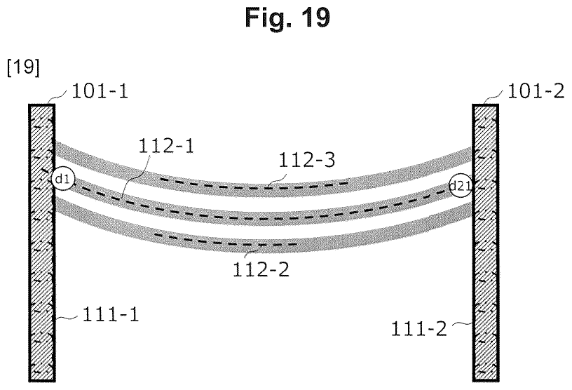

When the point cloud exists within the threshold from the approximate line at the selected point (Yes in step S324), the point cloud is set as an endpoint (step S326), and the three-dimensional model is created again. On the other hand, when there is no point cloud that can be an endpoint (No in step S324), a point cloud closest to the endpoint in the selected approximate line and within a threshold from the approximate line is set as an endpoint (step S327). In the present embodiment, as illustrated in FIG. 19, the point d1 exists at the position of the cursor 103-1 illustrated in FIG. 10, and the point d21 exists at the position of the cursor 103-2 illustrated in FIG. 10. Therefore, the arithmetic processing unit 3 creates the three-dimensional model 112-1 again using the point d1 and the point d21 as endpoints.

The threshold is set similarly to S114 to S117, and the distance from the approximate line to the point cloud is set as the threshold. Here, when creating the three-dimensional model again, all the point clouds within a threshold from the approximate line may be used between the endpoints of the approximate line, or a point cloud having the same color information as the cable 102-2 may be selectively used.

In the case of a cable, a three-dimensional model can be created at a place at a short distance from the fixed three-dimensional laser scanner 1-1, and a catenary curve can be estimated. The cable is installed on a wall surface of a utility pole or a house, the color of the cable is different from the color of the wall surface of the utility pole or the house when viewed in an image, and thus it is easy to distinguish the cables, and it is easier to acquire than the cable endpoint. These point clouds may be used as endpoints to extend the approximate line of the three-dimensional model. Accordingly, it is possible to create an accurate three-dimensional model.

As described above, in the present embodiment, by selecting the endpoints and enlarging the model according to the shape of the three-dimensional model, it is possible to create a three-dimensional model in which a place where the point cloud does not exist between the endpoints is corrected.

Here, in the present embodiment, by combining with the image, it is possible to make the endpoint visually easy to understand. In addition, when a point cloud serving as a boundary even at a long distance can be acquired from the fixed three-dimensional laser scanner 1-1 with respect to a target object having a characteristic shape, a three-dimensional model can be created accurately.

In addition, it is possible to accurately extend the three-dimensional model using the approximate line by learning in advance what shape the created three-dimensional model originally has.

### INDUSTRIAL APPLICABILITY

The present disclosure can be applied to the information and communication industry.

### REFERENCE SIGNS LIST

1-1 Fixed three-dimensional laser scanner
1-2 Camera
2 Storage medium
3 Arithmetic processing unit
4 Display unit
Apparatus
91 Point
92 Line
100 Target object
101-1, 101-2 Utility pole
100-1, 102-2, 102-3 Cable
111 Utility pole model
112 Cable model

1. An apparatus wherein
a three-dimensional model of a target object is created from point cloud data in which each point represents three-dimensional coordinates,
the three-dimensional model is superimposed on an image in which a target object of the three-dimensional model is photographed,
a superimposed image generated by the superimposition is displayed, and
when a range of the target object in the superimposed image is input, a three-dimensional model is created again using point cloud data in which a point is located in a range of the superimposed image.

2. The apparatus according to claim 1, wherein
a three-dimensional model is created again using a point cloud within a threshold from an approximate line of the three-dimensional model among point clouds located in the range of the superimposed image.

3. The apparatus according to claim 1, wherein
color information of the target object in the image is assigned to each point superimposed on the target object, and
when a range of a point cloud having the same color information as the target object is input, a three-dimensional model is created again using the point cloud located in the input range.

4. The apparatus according to claim 1, wherein
a size of the target object in the image is acquired by referring to a database storing information on the size of a random target object, and
the acquired range of the size of the target object is displayed on the superimposed image.

5. The apparatus according to claim 1, wherein
an approximate line of the three-dimensional model is calculated,
the three-dimensional model extends along the approximate line, and
the superimposed image is displayed by superimposing the three-dimensional model extended by an approximate line on the image.

6. A method comprising:
creating a three-dimensional model of a target object from point cloud data in which each point represents three-dimensional coordinates;
superimposing the three-dimensional model on an image in which a target object of the three-dimensional model is photographed;
displaying a superimposed image generated by the superimposition; and
creating a three-dimensional model again using point cloud data in which a point is located in a range of the superimposed image, when a range of the target object in the superimposed image is input.

7. A non-transitory computer-readable medium having computer-executable instructions that, upon execution of the instructions by a processor of a computer, cause the computer to function as the apparatus according to claim 1.
